(19) United States
(12) Patent Application Publication
(10) Pub. No.: US 2020/0034884 A1
(43) Pub. Date: Jan. 30, 2020

(54) Determining A Sales Conversion Window Based On Product Characteristics And User-Interest Events

(71) Applicant: AAXIS Group Corporation, Los Angeles, CA (US)

(72) Inventors: Naresh Ramanuja, Rancho Palos Verdes, CA (US); Prashant Mishra, Torrance, CA (US)

(73) Assignee: AAXIS Group Corporation, Los Angeles, CA (US)

(21) Appl. No.: 16/048,484

(22) Filed: Jul. 30, 2018

(51) Int. Cl. G06Q 30/02

(52) U.S. Cl. CPC G06Q 30/0264; G06Q 30/0255; G06Q 30/0254

(57) ABSTRACT

Operations include determining a sales conversion window based on product characteristics and/or user characteristics. Product characteristics may include a type of product, a price of the product, a style of the product, and a lifetime of the product. User characteristics may include conversion windows for prior purchases by a user, browsing history, and demographic information. The system may determine the sales conversion window based on events indicative of user interest. The events may include viewing a product, liking a product, sharing a product, adding a product to a cart for purchase, and purchasing a product. One or more events may be used to generate a model for the sales conversion window. Some embodiments execute one or more actions for generating sales during the computed sales conversion window.

### TECHNICAL FIELD

The present disclosure relates to sales conversions. In particular, the present disclosure relates to determining a sales conversion window based on product characteristics and user-interest events.

### BACKGROUND

A conversion window is a period of time during which a user is targeted for a sales conversion. As an example, conversion windows are used to determine a length of time to track a user after the user clicks on an ad. As another example, a system may present targeted ads to a user during a conversion window.

A system may use a default amount of time for conversion windows. As examples, thirty days and one day are popular conversion window times. Conversion windows may be set to different values to fit a situation. As an example, an administrator may adjust a conversion window to seven days to track a user until a seven-day promotion expires.

The approaches described in this section are approaches that could be pursued, but not necessarily approaches that have been previously conceived or pursued. Therefore, unless otherwise indicated, it should not be assumed that any of the approaches described in this section qualify as prior art merely by virtue of their inclusion in this section.

### BRIEF DESCRIPTION OF THE DRAWINGS

The embodiments are illustrated by way of example and not by way of limitation in the figures of the accompanying drawings. It should be noted that references to “an” or “one” embodiment in this disclosure are not necessarily to the same embodiment, and they mean at least one. In the drawings:

FIG. 1 illustrates a system in accordance with one or more embodiments;

FIG. 2 illustrates operations for generating a model for a sales conversion window in accordance with one or more embodiments;

FIG. 3 illustrates operations for determining a sales conversion window, based on a model, in accordance with one or more embodiments;

FIG. 4 illustrates an example of determining a sales conversion window in accordance with one or more embodiments; and

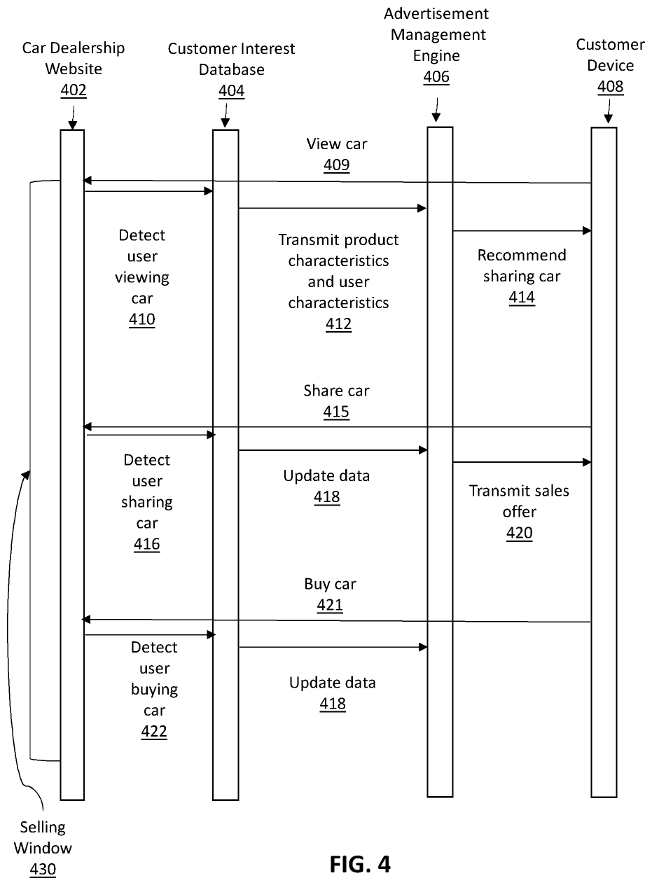

FIG. 5 shows a block diagram that illustrates a computer system in accordance with one or more embodiments.

### DETAILED DESCRIPTION

In the following description, for the purposes of explanation, numerous specific details are set forth in order to provide a thorough understanding. One or more embodiments may be practiced without these specific details. Features described in one embodiment may be combined with features described in a different embodiment. In some examples, well-known structures and devices are described with reference to a block diagram form in order to avoid unnecessarily obscuring the present invention.

1. GENERAL OVERVIEW

2. SALES CONVERSION SYSTEM

3. DETERMINING A SALES CONVERSION WINDOW
A. GENERATING A SALES CONVERSION WINDOW MODEL
B. DETERMINING A SALES CONVERSION WINDOW FOR A USER BASED ON THE MODEL

4. EXAMPLE EMBODIMENT

5. MISCELLANEOUS; EXTENSIONS

6. HARDWARE OVERVIEW

### 1. General Overview

A sales conversion window corresponds to a period of time during which a user is likely to purchase a product or service. Some embodiments determine a sales conversion window based on product characteristics and/or user characteristics. Product characteristics may include a type of product, a price of the product, a style of the product, a color of the product, and a lifetime of the product. User characteristics may include conversion windows for prior purchases by a user, browsing history, and demographic information. The sales conversion window may further be determined based on seasonality and/or weather. As an example, the sales conversion window for air conditioners may be shorter in the summer due to increased demand.

Some embodiments determine the sales conversion window based on events indicative of user interest. The system may identify user interest based on one or more detected events. The events may include viewing a product, liking a product, sharing a product, adding a product to a cart for purchase, and purchasing a product. One or more events may be used to generate a metric representing user interest in purchasing the product. Data corresponding to the level of interest over time, for a plurality of users, may be used to generate a model for the sales conversion window.

Some embodiments execute one or more actions for generating sales during the computed sales conversion window. Actions for generating sale may include presenting promotional offers or reminders on a seller website. Actions for generating sale may include contacting the user via email, text message, or phone call. Actions for generating a sale may include presenting an advertisement on a third-party website.

This Specification may describe, and/or the claims may recite, embodiments beyond those that are specifically included in this General Overview section.

### 2. Sales Conversion System

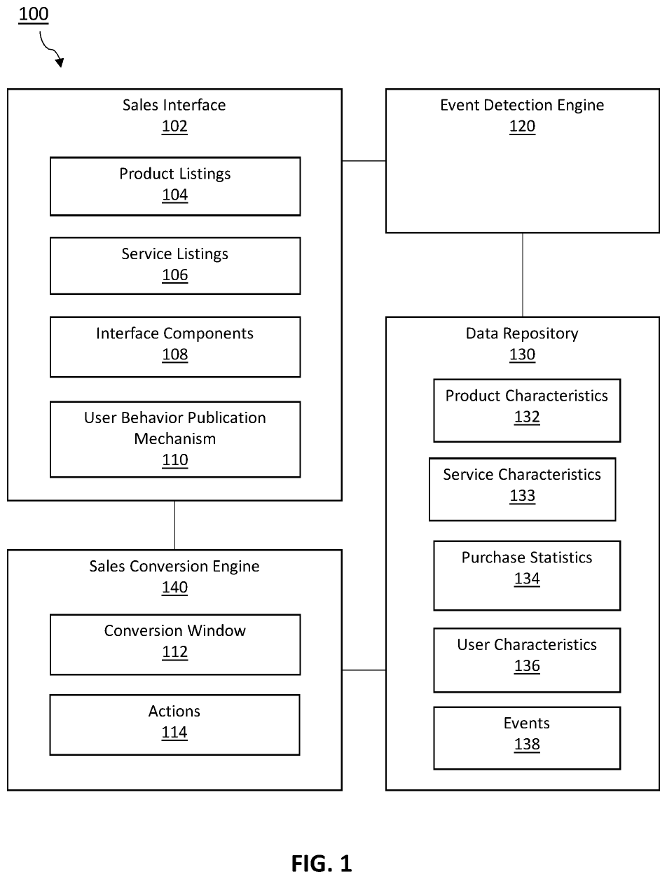

FIG. 1 illustrates a sales conversion system 100 in accordance with one or more embodiments. As illustrated in FIG. 1, the sales conversion system 100 includes a sales interface 102, event detection engine 120, data repository 130, and sales conversion engine 140. In one or more embodiments, the system 100 may include more or fewer components than the components illustrated in FIG. 1. The components illustrated in FIG. 1 may be local to or remote from each other. The components illustrated in FIG. 1 may be implemented in software and/or hardware. Each component may be distributed over multiple applications and/or machines. Multiple components may be combined into one application and/or machine. Operations described with respect to one component may instead be performed by another component.

In one or more embodiments, the sales interface 102 is an interface for displaying content, and receiving user input, related to selling goods or services. The sales interface 102 may be a website or application. The sales interface 102 may be associated with a brand or product. Alternatively, or additionally, the sales interface 102 may be associated with a web marketplace (e.g. an online action site) or a store (e.g. Hall Mart Stores' online presence).

Different components of the sales interface 102 may be specified in different languages. The behavior of user interface elements is specified in a dynamic programming language, such as JavaScript. The content of user interface elements is specified in a markup language, such as hypertext markup language (HTML) or extensible markup language (XML) User Interface Language (XUL). The layout of user interface elements is specified in a style sheet language, such as Cascading Style Sheets (CSS). Alternatively, sales interface 102 is specified in one or more other languages, such as Java, C, or C++.

The sales interface 102 may be implemented on one or more digital devices. The term “digital device” generally refers to any hardware device that includes a processor. A digital device may refer to a physical device executing an application or a virtual machine. Examples of digital devices include a computer, a tablet, a laptop, a desktop, a netbook, a mobile handset, a smartphone, a personal digital assistant (“PDA”), and/or a client device.

In one or more embodiments, the product listings 104 include information associated with products. The product listings 104 may include the name of a product. The product listings 104 may include a description of a product. The product listings 104 may include a picture of a product. As an example, product listings 104 may include a list of different cars that are for sale, with a description of each car and a photograph of each car.

In one or more embodiments, the service listings 106 include information associated with services. The service listings 106 may include the name of a service. The service listings 106 may include a picture associated with a service. The service listings 106 may include a description of a service. As an example, service listings 106 may include a list of different services available at a spa, with a description of each service.

In one or more embodiments, the interface components 108 are components for receiving user input in relation to goods and/or services. Interface components 108 may include an “add to cart” button for adding an item to a shopping cart. Interface components 108 may include a button and text-entry field to “search for a product.” Interface components 108 may include a “like” button for liking a good or service. Interface components 108 may include a “share” button. The system may receive user input selecting the share button, and, in response, share information about a good or service with one or more other users. Interface components 108 may further receive user input such as a name, address, and payment information, to facilitate the purchase of goods or services. Interface components 108 may include a button for voting on a product. Interface components 108 may include scroll bar(s) for viewing additional products and/or additional information about a particular product.

In an embodiment, the data repository 130 is any type of storage unit and/or device (e.g., a file system, collection of tables, or any other storage mechanism) for storing data related to a sales conversion window. The data repository 130 may include multiple different storage units and/or devices. The multiple different storage units and/or devices may or may not be of the same type or located at the same physical site. Further, the data repository 130 may be implemented or may execute on the same computing system as the sales interface 102, event detection engine 120, and sales conversion engine 140. Alternatively, or additionally, the data repository 130 may be implemented or executed on a computing system separate from the sales interface 102, event detection engine 120, and sales conversion engine 140. The data repository 130 may be communicatively coupled to the sales interface 102, event detection engine 120, and sales conversion engine 140 via a direct connection or via a network.

The data repository 130 may store and/or manage data used for identifying a sales conversion window and associated actions. The data may include product characteristics 132, service characteristics 133, purchase statistics 134, user characteristics 136, and events 138. The data repository may receive data from the sales interface. The data repository may receive data from multiple sales interfaces. As an example, one corporation may maintain several store websites, for different stores owned by the corporation. Alternatively, or additionally, the data repository 130 may be populated by voluntarily shared data from other websites or applications.

In one or more embodiments, the product characteristics 132 are features associated with a particular product. Product characteristics 132 may include a type of product, such as books or shampoo. Product characteristics may include color, style, price, and/or size. Product characteristics 132 may include usage characteristics associated with a product. The usage characteristics may correspond to a frequency of purchase or lifetime associated with a product. As an example, users typically replace razors every four days, while users typically replace cars every seven years.

In one or more embodiments, the service characteristics 133 are features associated with a particular service. Service characteristics 133 may include a type of service, such as a massage or babysitting. Service characteristics 133 may include a location associated with a service. Service characteristics 133 may include usage characteristics associated with a service. The usage characteristics may correspond to a frequency of purchase associated with a service. As an example, the average customer purchases car washing services on a biweekly basis.

In one or more embodiments, the purchase statistics 134 comprise historical sales conversion information associated with a product or service. The purchase statistics may relate to a particular product or service (e.g., Joe's chocolate chip cookies). Alternatively, or additionally, the purchase statistics may relate to a type or category or service (e.g., cookies). As an example of a purchase statistic, users, on average, purchase makeup within one day of first viewing the makeup on a website. As another example, for products that cost between one thousand dollars and five thousand dollars, users typically research a product for thirty days before purchasing the product. As another example, users that share a clothing item typically purchase the clothing item within three days of sharing the clothing item.

In one or more embodiments, the user characteristics 136 comprise information about a user. User characteristics 136 may include a user's age. User characteristics 136 may include a user's city of residence. User characteristics 136 may include a location from which a user is viewing a web page.

The user characteristics 136 may include information about a user's prior purchases and conversion actions. The user characteristics may include historical sales conversion information associated with a user. The historical sales conversion information may relate to events detected in relation to the user, such as viewing, purchasing, or liking products or services. As an example, the user viewed a dress on May 5, 2018. The user bought the dress on May 10, 2018. The user characteristics may include purchasing habits associated with the user. As an example, the user purchases an average of four dresses a year from a particular website. The user characteristics may include timing associated with prior purchase patterns. As an example, ninety percent of a particular user's purchases are made during the first week of the month.

The user characteristics 136 may include financial information associated with a user. The system may estimate financial information based on the user's location. As an example, residents of a particular zip code have a particular median income. The median income associated with a user's location may be used to estimate the user's income. Alternatively, or additionally, the system may obtain financial information voluntarily disclosed by a user. As an example, a store may obtain detailed financial information about a user when the user applies for a credit card issued by the store.

In one or more embodiments, the events 138 are user actions associated with a product or service. Events 138 may include viewing a product (i.e., the system serves a page displaying the product to the user's device). Events 138 may include spending a threshold amount of time on a page displaying a service. Events 138 may include liking a product, voting on a product, or sharing a product. Events 138 may include adding a product to a wish list, gift list, or cart. Events 138 may include navigating to a shipping page with an item in a cart. Events 138 may include navigating to a billing page with an item in a cart. Events 138 may include purchasing a product. As another example, events 138 may include executing a search which results in display of a product or service.

In one or more embodiments, the conversion window 112 is a window within which a user is likely to make a purchase. As an example, based on characteristics of a particular user, in relation to similar users, the system may predict that the user will lose interest in purchasing a product one week after initially viewing the product. As another example, the average time that elapses between users viewing a car and purchasing a car may correspond to a conversion window of three months.

The conversion window 112 may represent the bounds of a conversion curve indicating the evolution of a user's interest in an item over time. A user's intent to purchase a product or service may be represented numerically. As an example, when a user first views a product, the system assigns the user a numerical intent rating of 0.1. When a user shares the item the following day, the system increases the intent rating to 0.5. When the user purchases the item ten days later, the system increases the intent rating to 1. The conversion curve may track how the user's interest rises and falls over time. The conversion curve may be used to identify a point in time when a user's interest in a product or service peaks.

In one or more embodiments, the actions 114 are actions for generating a conversion event. An action 114 may encourage the purchase of a product or service. As an example, the system presents an advertisement for a service to the user, to encourage the user to buy the service. As another example, the system displays a modal offering a discount if the user buys an item within the next hour. As another example, the system sends the user an email or text message encouraging the purchase of an item. As another example, the system may instruct a salesperson to call an individual to discuss purchasing an item. Alternatively, or additionally, an action 114 may encourage other conversions by the user, such as sharing a product or adding a product to a cart. As an example, the system displays a modal including an “Add to cart” button.

In one or more embodiments, the user behavior publication mechanism 110 is hardware and/or software configured to detect and publish information about user behavior. The user behavior publication mechanism 110 may, for example, include a script executing on the sales interface 102 which detects user events. The script may detect the receipt of user input. The user input may include a click or typed data. The user input may include a phone call or chat with customer service. The user input may include submitting a review. The user input may include viewing a preexisting review. The user input may include submitting a question to other reviewers. As an example, a user submits a question, “Is the dashboard all leather or are there plastic inserts in the dashboard?” The script may identify a time between one or more user events. The time between events may be identified, as a nonlimiting example, by starting a timer upon detecting a first event, and, upon detecting a second event, stopping the timer and recording the elapsed time. Responsive to detecting a user event, the user behavior publication mechanism 110 may transmit a notification to the event detection engine 120.

In one or more embodiments, the event detection engine 120 is hardware and/or software configured to detect events. The event detection engine 120 may detect an event directly by monitoring the sales interface 102. Alternatively, or additionally, the event detection engine 120 may detect an event indirectly by receiving a notification from the user behavior publication mechanism 110.

In one or more embodiments, the sales conversion engine 140 includes hardware and/or software configured to determine a conversion window 112. The sales conversion engine 140 may further determine actions 114 associated with the conversion window 112.

In one or more embodiments, the sales conversion engine 140 may generate a model representing the conversion window 112. The model may be based on historical user data. The model may include a curve representing user interest in a product over time.

In one or more embodiments, the sales conversion engine 140 may determine one or more appropriate actions 114 based on a user's position in the sales conversion window. As an example, historically, users typically share a particular product four days after viewing the product. Accordingly, four days after a new user views the product, the system identifies an appropriate action to execute. The system determines that the appropriate action is to display a notification suggesting that the user shares the item.

### 3. Determining a Sales Conversion Window

A. Generating a Sales Conversion Window Model

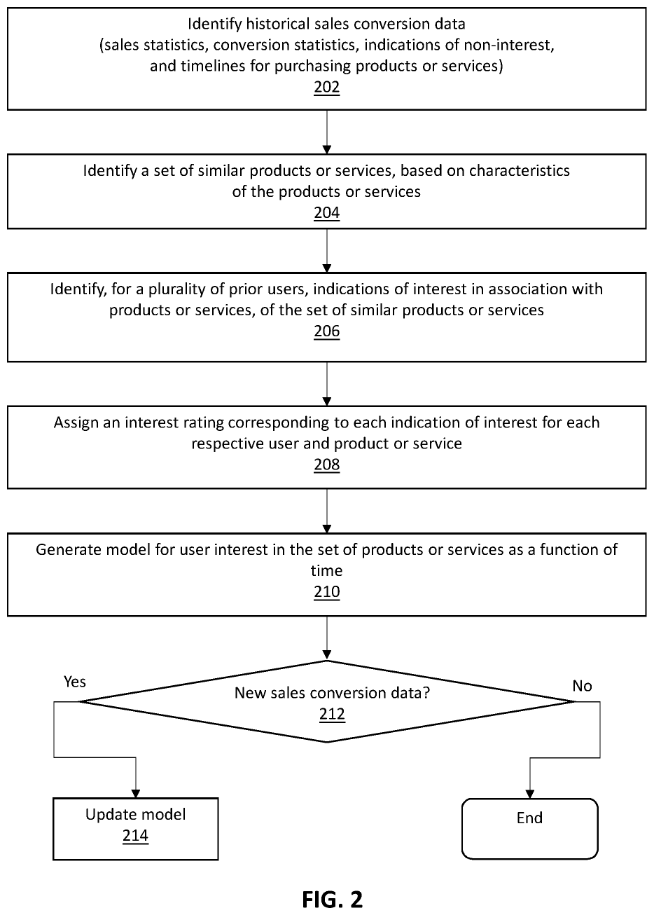

FIG. 2 illustrates an example set of operations for generating a model for a sales conversion window in accordance with one or more embodiments. One or more operations illustrated in FIG. 2 may be modified, rearranged, or omitted altogether. Accordingly, the particular sequence of operations illustrated in FIG. 2 should not be construed as limiting the scope of one or more embodiments.

In an embodiment, the sales conversion engine identifies historical sales conversion data (Operation 202). The sales conversion engine may identify historical sales conversion data stored to the data repository. The historical sales conversion data may include sales statistics. The historical sales conversion data may include conversion statistics, such as event logs indicating times at which users viewed, shared, or purchased products or services. The historical sales conversion data may include indications of non-interest, such as detecting that a user closed an advertisement for a service without clicking on the body of the advertisement. The historical sales conversion data may include timelines for purchasing products or services.

In an embodiment, the sales conversion engine identifies a set of similar products or services, based on characteristics of the products or services (Operation 204). The sales conversion engine may cluster products or services based on similar characteristics. As examples, the sales conversion engine may cluster products based on category, size, price, or pattern. The sales conversion engine may group products based on visual similarity. The sales conversion engine may use machine learning to cluster like products. As an example, the system may use a machine learning algorithm to identify visual similarity between shoes.

In an embodiment, the sales conversion engine identifies, for a plurality of prior users, indications of interest in products or services, of the set of similar products or services (Operation 206). The sales conversion engine may analyze the historical sales conversion data to identify the indications of interest. As an example, the sales conversion engine determines that a user, Jim Johnson, viewed a particular shirt on Jan. 1, 2018. The system further determines that Jim Johnson liked the shirt on Jan. 2, 2018 and purchased the shirt on Jan. 3, 2018.

In an embodiment, the sales conversion engine assigns an interest rating corresponding to each indication of interest for each respective user and product or service (Operation 208). The interest rating may correspond to an action performed by a user. As an example, the system may assign an interest rating of 0.1 for viewing an item. As another example, the system may assign an interest rating of 0.5 for sharing an item. As another example, the system may assign an interest rating of 0.7 for calling a customer service representative to inquire about a service upgrade. The system may increment or decrement the interest rating based on additional factors, such as other actions performed or time elapsed between actions.

In an embodiment, the sales conversion engine generates a model for user interest in the set of products or services as a function of time (Operation 210). The sales conversion engine may identify user interest over time for each of a plurality of users. As an example, User 1 viewed an item, then purchased the item twenty days later. The system assigns User 1 an interest rating which goes from 0 to 0.1 to 1 over the course of twenty days. User 2 shared an item, then purchased the item ten days later. The system assigns User 2 an interest rating which goes from 0 to 0.5 to 1 over the course of ten days.

Based on expressions of user interest over time for the set of users, the system may generate a model. The system may generate a best fit curve for the set of users' interest ratings as a function of time. The curve may be generated by, for example, linear regression. The model may be tailored by reducing the error on a best fit curve to the data set comprising user interest over time for the set of users. As another example, the model may be generated using neural networks.

The system may modify the model to account for temporal changes in spending patterns. As an example, users may be more likely to purchase items the day after Thanksgiving (“Black Friday”). As another example, users may be more likely to purchase items on payday (i.e., the first of the month). Based on temporal changes in spending patterns, the system may increment or decrement the anticipated user interest at a particular time.

The system may update the model to add or remove similar products from the data set. As an example, the model for a data set including ten different clothing items has a high degree of error. Accordingly, the system removes one of the ten clothing items and recomputes the model. As another example, products grouped by color may result in a high-error model. Accordingly, the system groups the products by style instead of color and recomputes the model. The system may continue adjusting the groupings and recomputing the model until the error falls below a threshold level.

In an embodiment, the sales conversion engine receives new sales conversion data (Operation 212). The sales conversion engine may refresh the data set when a user executes an action such as buying or viewing a product.

In an embodiment, the sales conversion engine updates the model (Operation 214). The sales conversion engine may update the model whenever the system receives new data. Alternatively, or additionally, the model may be recomputed periodically. As an example, the model may be recomputed with refreshed data on a daily or weekly basis.

B. Determining a Sales Conversion Window for a User Based on the Model

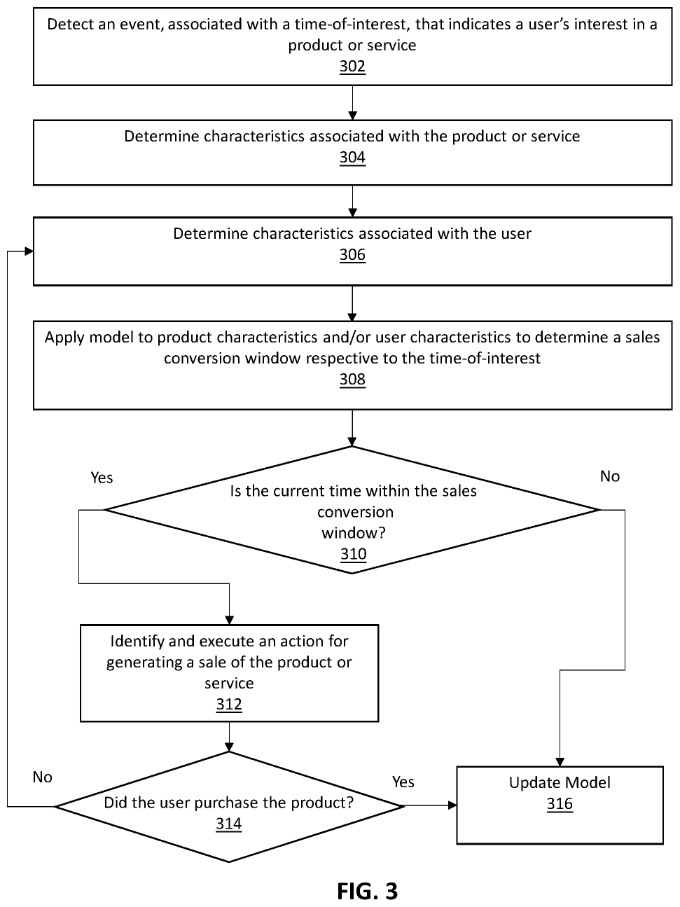

FIG. 3 illustrates an example set of operations for determining a sales conversion window for a user based on the model in accordance with one or more embodiments. One or more operations illustrated in FIG. 3 may be modified, rearranged, or omitted altogether. Accordingly, the particular sequence of operations illustrated in FIG. 3 should not be construed as limiting the scope of one or more embodiments.

In an embodiment, the event detection engine detects an event, associated with a time-of-interest, that indicates a user's interest in a product or service (Operation 302). The event detection engine may receive a notification from the user behavior publication mechanism associated with the event. As an example, the event detection engine receives a notification that the user clicked on an advertisement for a tour of Venice at 3:55 pm on Mar. 5, 2018. Alternatively, the event detection engine may directly detect an event. As an example, the event detection engine manages a script that detects a user adding an item to a cart at 10:01 am on Jan. 1, 2019.

In an embodiment, the system detects an event based on serving content to the sales interface. As an example, the system may serve a web page including a product. The system may identify one or more products which were displayed on a served page. As another example, the system may add an item to a shopping cart.

In an embodiment, the system detects an event using a script running on a web page. The script may capture clickstream data. The script may be used to detect actions executed on the sales interface, such as clicking on a product, voting on a product, reviewing a product, or purchasing a service.

In an embodiment, the event detection engine detects an event by detecting a cookie. The system may use a cookie, stored to the user's device, to track information. Information tracked using a cookie may include, as examples, the user's browsing activity and items added to the user's cart. The system may detect a stored cookie to identify actions executed by the user.

In an embodiment, the system determines an amount of time that a web page has been displayed. The amount of time may be determined based on the time elapsed between serving two web pages. The time elapsed may be reconstructed using server logs. Alternatively, or additionally, the system may use a script, running in a website, that captures the amount of time a browser window was open on a user's device.

In an embodiment, the event detection engine detects an event by monitoring a phone line or phone records. The event detection engine may detect calls received by customer service representatives. The event detection engine may identify a user associated with the call based on the caller's phone number and/or information provided by the caller during the conversation. The system may further analyze a customer service ticket to correlate an event with intent. As an example, based on a call with a customer, a customer service agent creates a ticket. The system processes the ticket logs to find agent notes indicating a level of user interest.

In an embodiment, the sales conversion engine determines characteristics associated with the product or service. (Operation 304). The sales conversion engine may determine the product characteristics by querying the data repository. The sales conversion engine may retrieve a plurality of product characteristics. As an example, the sales conversion engine determines that a product that a user shared is a red shirt, size small, and priced at $35. The sales conversion engine may select characteristics that are relevant to the selling window. As an example, the system uses a model based on the lifetime of a set of similar products. Accordingly, the system identifies the lifetime of the product associated with the detected event.

In an embodiment, the sales conversion engine determines characteristics associated with the user. (Operation 306). Determining characteristics associated with the user may include determining purchasing habits associated with the user. As an example, the sales conversion engine determines that the user bought clothing from the sales interface on a monthly basis. Determining characteristics associated with the user may include determining timing associated with prior purchase patterns. As an example, the sales conversion engine determines that, the last time the user bought a shirt via the sales interface, the user purchased the shirt four hours after initially viewing the shirt. The sales conversion engine may determine the user characteristics by querying the data repository.

In an embodiment, the sales conversion engine determines financial information associated with the user. The sales conversion engine may determine the financial information based on the user's location. The user's location may be determined based on a location function in the sales interface, which detects the location from which the user is viewing the sales interface. The system may identify financial information associated with other users in the user's city or zip code. The financial information may correspond to a pay schedule indicative of times when a user is likely to make a purchase. As an example, the system determines that grocery purchases in a particular neighborhood peak on the first and fourteenth of every month. The system may estimate a current user's financial information, based on other users in the same location as the current user.

In an embodiment, the sales conversion engine applies the model to the product characteristics and/or user characteristics to determine a sales conversion window respective to the time-of-interest (Operation 308). The sales conversion engine may identify an appropriate model, as determined above in Section 3A with respect to FIG. 2. The system may select a model based on product similarity. The model may be specific to one product (i.e., a particular make and model of car). Alternatively, or additionally, the model may be based on a set of similar products (i.e., red sedans priced below $30,000). Alternatively, or additionally, the system may select a model based on user similarity. As an example, the system selects a model which was calculated based on users from the same zip code as a current user.

Upon identifying an appropriate model, the system may estimate the current user's projected level of interest based on the model. As an example, the model is a curve of user interest over time. The curve includes data points representing viewing a product, sharing a product, adding a product to a cart, and purchasing a product. The system determines where the current user fits on the curve, based on the present time in association with actions the current user has executed. The user shared a product two days ago. Based on the time elapsed since sharing the product, the system determines the user's position on the curve. Based on the user's position on the curve, the user is predicted to have a peak interest in the product three days from the present date.

The system may adjust the sales conversion window based on the product characteristics and/or user characteristics. As an example, the system may adjust the predicted levels of interest based on a relationship between usage characteristics and environmental conditions. Historical data may indicate that, in areas where snow is frequent, tires are replaced sixty percent faster than in areas where snow is infrequent. Accordingly, the system may adjust the model upon determining that the current user resides in a snowy area.

Using the user's position in the model, and the properties of the model itself, the system may determine the sales conversion window with respect to time. Identifying the sales conversion window may comprise identifying a start time and/or end time for the sales conversion window. As an example, the sales conversion window starts when the user first viewed the product. According to the model, after forty-four days, ninety percent of users are no longer likely to purchase the product. The system identifies an end time for the sales conversion window, corresponding to forty-five days after the user first viewed the product.

In an embodiment, the sales conversion engine determines whether the current time is within the sales conversion window. (Operation 310). The sales conversion engine may compare the time elapsed since the detected event to the sales conversion window. As an example, users typically purchase a flight from Los Angeles to Tokyo seven weeks after first researching flight prices for the trip. The sales conversion engine determines that, for a user that first researched flight prices for Los Angeles to Tokyo three weeks ago, the current time is within the sales conversion window.

In an embodiment, the sales conversion engine identifies and executes an action for generating a sale of the product or service (Operation 312). The sales conversion engine may identify an appropriate action, based on the time of the detected event in relation to the sales conversion window. As an example, based on the model applied to the user, the system predicts that the user is most likely to purchase a lawnmower fifteen days after first viewing the lawnmower on a manufacturer's webpage. Accordingly, the system determines that, fifteen days after the user viewed the lawnmower, the appropriate action is to send the user an email advertising the lawnmower. The system may identify actions by, for example, querying a look-up table comprising interest ratings and associated actions.

Upon identifying an action, the sales conversion engine may initiate execution of the action. The sales conversion engine may execute the action directly. As examples, the sales conversion engine may transmit an email or text message. Alternatively, or additionally, the sales conversion engine may recommend execution of the action. As an example, the sales conversion engine may transmit an instruction to the sales interface to display an alert about purchasing a product. As another example, the sales conversion engine may transmit a notification to an administrator, suggesting that the administrator call a user to discuss purchasing a product.

The system may identify and execute additional actions based on the time of the detected event in relation to the sales conversion window. As an example, the system transmits an advertisement to a user fifteen days after the user searched for a lawnmower. The user's likelihood of purchasing the lawnmower is expected to steadily decline after day fifteen. Accordingly, eighteen days after the user searched for the lawnmower, the system sends an email to the user offering thirty percent off on lawnmowers.

In an embodiment, the sales conversion engine determines whether the user purchased the product (Operation 314). The system may detect purchase of the product as described above with respect to Operation 302.

In an embodiment, the sales conversion engine updates the model (Operation 316). The system may continually update the model as additional users take actions with respect to products.

In an embodiment, the sales conversion engine determines inventory purchase for a product, based on a plurality of sales conversion windows. The system may aggregate sales conversion windows, for a plurality of customers, with respect to a particular product. Based on the aggregated sales conversion windows, the system may determine inventory requirements. As an example, the system determines that seventy-five customers are likely to purchase a particular toy on December 1. Accordingly, the system recommends that inventory of the toy is increased prior to December 1.

### 4. Example Embodiment

The following detailed example illustrates operations in accordance with one or more embodiments. The following detailed example should not be construed as limiting the scope of any of the claims. A user, John Smith, is viewing a car dealership website 402 on a customer device 408. John clicks on, and views, a detailed description of a Model Y car (Operation 409). A script executing on the car dealership website detects that John is viewing the Model Y (Operation 410).

Upon detecting that John has viewed the car, the system updates the customer interest database 404 to include the time at which John viewed the car, and details about the car viewed. The customer interest database 404 transmits product characteristics and user characteristics to the advertisement management engine (Operation 412). The product characteristics specify that the car John viewed is black, a sedan, and a Model Y. The product characteristics specify a suggested retail price for the car. The product characteristics specify that historically, purchasers typically replace similar cars after six years of use. The customer interest database 404 further transmits user characteristics about John. The user characteristics specify other products that John has viewed and purchased.

Based on the received product characteristics and user characteristics, the advertisement management engine identifies a selling window 430, during which John is likely to purchase the car. Using historical data for users that bought the same car and similar cars, the advertisement management engine generates a mathematical model for interest over time. The advertisement management engine tailors the model, based on previous users similar to John. The resulting formula represents an estimate of John's interest in the car over time. John's interest is represented numerically, with values from 0 (no interest) to 1 (highest interest). When John initially viewed the car, John's interest rating was 0.1. At the present time, based on the projected growth in interest, John's interest rating is 0.3.

Based on John's current level of interest, the advertisement management engine identifies an action. Using a look-up-table for cars, the advertisement management engine determines that at level 0.3, the appropriate action is to recommend sharing the car with other users.

Accordingly, the advertisement management engine recommends that John shares the car, by initiating display, on customer device 408, of a modal including the text “Share Model Y!” and a button for sharing (Operation 414).

John shares the car (Operation 415). The system detects that John has clicked on the “share” button. (Operation 416). The system detects the click via a script running on the car dealership website. The system updates the data stored to the customer interest database 404, to reflect that John has shared the Model Y.

The advertisement management engine retrieves the updated data from the customer interest database (Operation 418). The advertisement management engine identifies the time at which John shared the car. The advertisement management engine updates the model to indicate that John has shared the car. Sharing the car corresponds to an increase in user interest. Accordingly, the advertisement management engine updates John's interest rating to 0.7. The advertisement management engine identifies a recommended action for users with an interest level of 0.7. The look-up table revels that, for users with an interest level of 0.7, the appropriate action is to transmit a sales offer.

The advertisement management engine transmits a sales offer to the customer device (Operation 420). The advertisement management engine transmits an email to the customer device. The email includes information about a reduced price, offered for a limited time.

John decides to take advantage of the offer. John orders the car on the car dealership website (Operation 421). The car dealership website detects John executing actions on the website to buy the car (Operation 422). Responsive to detecting John ordering the car, the system updates the customer interest database.

The advertisement management engine retrieves the updated data indicating the time at which John purchased the car (Operation 418). John's actions and the times at which the actions were executed are used to refine the model for use with respect to future users.

### 5. Miscellaneous; Extensions

Embodiments are directed to a system with one or more devices that include a hardware processor and that are configured to perform any of the operations described herein and/or recited in any of the claims below.

In an embodiment, a non-transitory computer readable storage medium comprises instructions which, when executed by one or more hardware processors, causes performance of any of the operations described herein and/or recited in any of the claims.

Any combination of the features and functionalities described herein may be used in accordance with one or more embodiments. In the foregoing specification, embodiments have been described with reference to numerous specific details that may vary from implementation to implementation. The specification and drawings are, accordingly, to be regarded in an illustrative rather than a restrictive sense. The sole and exclusive indicator of the scope of the invention, and what is intended by the applicants to be the scope of the invention, is the literal and equivalent scope of the set of claims that issue from this application, in the specific form in which such claims issue, including any subsequent correction.

### 6. Hardware Overview

According to one embodiment, the techniques described herein are implemented by one or more special-purpose computing devices. The special-purpose computing devices may be hard-wired to perform the techniques, or may include digital electronic devices such as one or more application-specific integrated circuits (ASICs), field programmable gate arrays (FPGAs), or network processing units (NPUs) that are persistently programmed to perform the techniques, or may include one or more general purpose hardware processors programmed to perform the techniques pursuant to program instructions in firmware, memory, other storage, or a combination. Such special-purpose computing devices may also combine custom hard-wired logic, ASICs, FPGAs, or NPUs with custom programming to accomplish the techniques. The special-purpose computing devices may be desktop computer systems, portable computer systems, handheld devices, networking devices or any other device that incorporates hard-wired and/or program logic to implement the techniques.

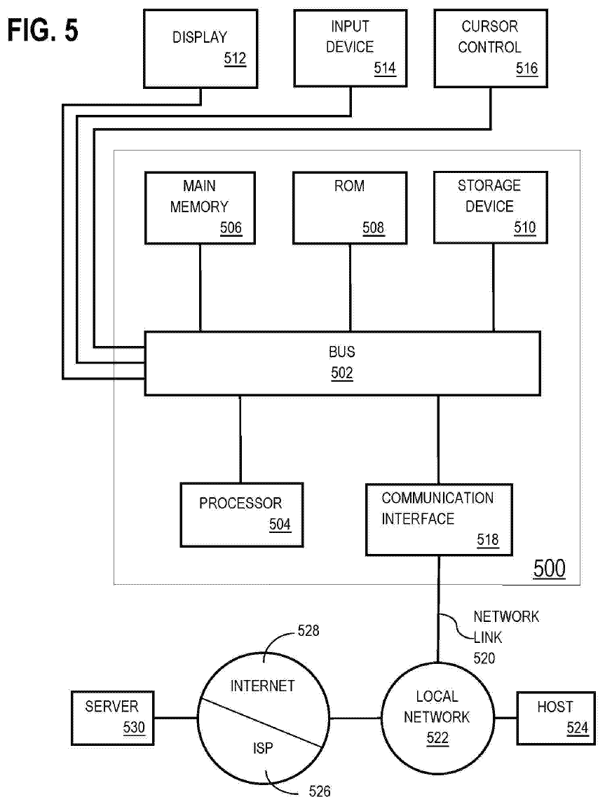

For example, FIG. 5 is a block diagram that illustrates a computer system 500 upon which an embodiment of the invention may be implemented. Computer system 500 includes a bus 502 or other communication mechanism for communicating information, and a hardware processor 504 coupled with bus 502 for processing information. Hardware processor 504 may be, for example, a general-purpose microprocessor.

Computer system 500 also includes a main memory 506, such as a random-access memory (RAM) or other dynamic storage device, coupled to bus 502 for storing information and instructions to be executed by processor 504. Main memory 506 also may be used for storing temporary variables or other intermediate information during execution of instructions to be executed by processor 504. Such instructions, when stored in non-transitory storage media accessible to processor 504, render computer system 500 into a special-purpose machine that is customized to perform the operations specified in the instructions.

Computer system 500 further includes a read only memory (ROM) 508 or other static storage device coupled to bus 502 for storing static information and instructions for processor 504. A storage device 510, such as a magnetic disk or optical disk, is provided and coupled to bus 502 for storing information and instructions.

Computer system 500 may be coupled via bus 502 to a display 512, such as a cathode ray tube (CRT), for displaying information to a computer user. An input device 514, including alphanumeric and other keys, is coupled to bus 502 for communicating information and command selections to processor 504. Another type of user input device is cursor control 516, such as a mouse, a trackball, or cursor direction keys for communicating direction information and command selections to processor 504 and for controlling cursor movement on display 512. This input device typically has two degrees of freedom in two axes, a first axis (e.g., x) and a second axis (e.g., y), that allows the device to specify positions in a plane.

Computer system 500 may implement the techniques described herein using customized hard-wired logic, one or more ASICs or FPGAs, firmware and/or program logic which in combination with the computer system causes or programs computer system 500 to be a special-purpose machine. According to one embodiment, the techniques herein are performed by computer system 500 in response to processor 504 executing one or more sequences of one or more instructions contained in main memory 506. Such instructions may be read into main memory 506 from another storage medium, such as storage device 510. Execution of the sequences of instructions contained in main memory 506 causes processor 504 to perform the process steps described herein. In alternative embodiments, hard-wired circuitry may be used in place of or in combination with software instructions.

The term “storage media” as used herein refers to any non-transitory media that store data and/or instructions that cause a machine to operate in a specific fashion. Such storage media may comprise non-volatile media and/or volatile media. Non-volatile media includes, for example, optical or magnetic disks, such as storage device 510. Volatile media includes dynamic memory, such as main memory 506. Common forms of storage media include, for example, a floppy disk, a flexible disk, hard disk, solid state drive, magnetic tape, or any other magnetic data storage medium, a CD-ROM, any other optical data storage medium, any physical medium with patterns of holes, a RAM, a PROM, and EPROM, a FLASH-EPROM, NVRAM, any other memory chip or cartridge, content-addressable memory (CAM), and ternary content-addressable memory (TCAM).

Storage media is distinct from but may be used in conjunction with transmission media. Transmission media participates in transferring information between storage media. For example, transmission media includes coaxial cables, copper wire and fiber optics, including the wires that comprise bus 502. Transmission media can also take the form of acoustic or light waves, such as those generated during radio-wave and infra-red data communications.

Various forms of media may be involved in carrying one or more sequences of one or more instructions to processor 504 for execution. For example, the instructions may initially be carried on a magnetic disk or solid-state drive of a remote computer. The remote computer can load the instructions into its dynamic memory and send the instructions over a telephone line using a modem. A modem local to computer system 500 can receive the data on the telephone line and use an infra-red transmitter to convert the data to an infra-red signal. An infra-red detector can receive the data carried in the infra-red signal and appropriate circuitry can place the data on bus 502. Bus 502 carries the data to main memory 506, from which processor 504 retrieves and executes the instructions. The instructions received by main memory 506 may optionally be stored on storage device 510 either before or after execution by processor 504.

Computer system 500 also includes a communication interface 518 coupled to bus 502. Communication interface 518 provides a two-way data communication coupling to a network link 520 that is connected to a local network 522. For example, communication interface 518 may be an integrated-services digital network (ISDN) card, cable modem, satellite modem, or a modem to provide a data communication connection to a corresponding type of telephone line. As another example, communication interface 518 may be a local area network (LAN) card to provide a data communication connection to a compatible LAN. Wireless links may also be implemented. In any such implementation, communication interface 518 sends and receives electrical, electromagnetic or optical signals that carry digital data streams representing various types of information.

Network link 520 typically provides data communication through one or more networks to other data devices. For example, network link 520 may provide a connection through local network 522 to a host computer 524 or to data equipment operated by an Internet Service Provider (ISP) 526. ISP 526 in turn provides data communication services through the world-wide packet data communication network now commonly referred to as the “Internet” 528. Local network 522 and Internet 528 both use electrical, electromagnetic or optical signals that carry digital data streams. The signals through the various networks and the signals on network link 520 and through communication interface 518, which carry the digital data to and from computer system 500, are example forms of transmission media.

Computer system 500 can send messages and receive data, including program code, through the network(s), network link 520 and communication interface 518. In the Internet example, a server 350 might transmit a requested code for an application program through Internet 528, ISP 526, local network 522 and communication interface 518.

The received code may be executed by processor 504 as it is received, and/or stored in storage device 510, or other non-volatile storage for later execution.

In the foregoing specification, embodiments of the invention have been described with reference to numerous specific details that may vary from implementation to implementation. The specification and drawings are, accordingly, to be regarded in an illustrative rather than a restrictive sense. The sole and exclusive indicator of the scope of the invention, and what is intended by the applicants to be the scope of the invention, is the literal and equivalent scope of the set of claims that issue from this application, in the specific form in which such claims issue, including any subsequent correction.

What is claimed is:

1. A non-transitory computer readable medium comprising instructions which, when executed by one or more hardware processors, causes performance of operations comprising:
detecting an event, associated with a particular time, that indicates a user's interest in a product;
determining characteristics associated with the product;
based on the characteristics associated with the product: identifying a sales conversion window, with relation to the particular time, for a sale of the product to the user.

2. The medium of claim 1, wherein the operations further comprise:
executing an action for generating the sale of the product to the user during the sales conversion window.

3. The medium of claim 1, wherein the operations further comprise:
presenting an advertisement to the user during the sales conversion window.

4. The medium of claim 1, wherein identifying the sales conversion window comprises identifying a start time for the sales conversion window.

5. The medium of claim 1, wherein identifying the sales conversion window comprises identifying an end time for the sales conversion window.

6. The medium of claim 1, wherein identifying the sales conversion window comprises identifying both a start time for the sales conversion window and an end time for the sales conversion window.

7. The medium of claim 1, wherein the characteristics associated with the product comprise historical sales conversion information associated with the product.

8. The medium of claim 1, wherein the characteristics associated with the product comprise a type of the product.

9. The medium of claim 1, wherein the characteristics associated with the product comprise usage characteristics associated with the product.

10. The medium of claim 9, wherein identifying the sales conversion window is further based on a relationship between the usage characteristics associated with the product and environmental conditions.

11. The medium of claim 1, wherein detecting the event comprises detecting an action by the user related to viewing of the product or related to viewing of a description of the product.

12. The medium of claim 1, wherein detecting the event comprises detecting a cookie indicative of an interest in the product.

13. The medium of claim 1, wherein the operations further comprise:
determining a plurality of sales conversion windows for sale of the product to a respective plurality of users;
determining inventory purchase for the product based on the plurality of sales conversion windows.

14. A non-transitory computer readable medium comprising instructions which, when executed by one or more hardware processors, causes performance of operations comprising:
detecting an event, associated with a particular time, that indicates a user's interest in a product;
determining characteristics associated with the user;
based on the characteristics associated with the user: identifying a sales conversion window, with relation to the particular time, for a sale of the product to the user;
presenting a notification or executing an action associated with the sale of the product to the user during the sales conversion window.

15. The medium of claim 14, wherein the characteristics associated with the user comprise historical sales conversion information associated with the user.

16. The medium of claim 14, wherein the characteristics associated with the user comprise purchasing habits associated with the user.

17. The medium of claim 14, wherein the characteristics associated with the user comprise financial information associated with the user.

18. The medium of claim 14, wherein the characteristics associated with the user comprise timing associated with prior purchase patterns.

19. The medium of claim 14, wherein the operations further comprise:
presenting an advertisement to the user during the sales conversion window.

20. The medium of claim 14, wherein determining the sales conversion window comprises identifying an end time for the sales conversion window.
